(19) United States
(12) Patent Application Publication
(10) Pub. No.: US 2005/0231803 A1
(43) Pub. Date: Oct. 20, 2005

(54) Retroreflective devices and systems

(76) Inventors: Vincent A. Handerek, Grays (GB); Leslie C. Laycock, High Ongar (GB)

Correspondence Address: NIXON & VANDERHYE, PC, 901 NORTH GLEBE ROAD, 11TH FLOOR, ARLINGTON, VA, 22203, US

(21) Appl. No.: 10/516,951

(22) PCT Filed: Oct. 14, 2004
(86) PCT No.: PCT/GB04/04349

§ 371 Date: Dec. 6, 2004

(30) Foreign Application Priority Data
Oct. 17, 2003 (GB) 0324418.3

(51) Int. Cl. G02B 5/122

(52) U.S. Cl. 359/529

(57) ABSTRACT

This invention relates to retroreflective devices and systems incorporating such devices; the term “retroreflective devices” as used herein being intended to encompass generally optical components used for returning radiation automatically from a remote location toward an optical source. In one aspect, an embodiment of the invention is a retroreflective device comprising a lens having a non-planar outer surface; and a liquid crystal cell having a non-planar layer comprising liquid crystal material, said non-planar layer having a shape corresponding with that of the non-planar outer surface of the lens. The device includes a reflective part arranged to retroreflect a radiation beam passing through the lens, and the liquid crystal cell is arranged to modulate one or more characteristics of said retroreflected radiation beam. Embodiments of the invention are advantageous for use in applications that require thin, transmissive modulators that are compatible with non-planar retroreflecting devices. Liquid crystals offer a useful modulation action for optical path lengths of 1 mm and less, and, since the local orientation of their molecular symmetry axes can be controlled by the fabrication process so as to vary with position, they can be made to be locally optimum over the whole of the reflecting surface of the non-planar retroreflecting device. In addition, liquid crystal devices are associated with low power requirements, which make them advantageous for use in power-limited applications.

### FIELD OF THE INVENTION

This invention relates to retroreflective devices and systems incorporating such devices; the term “retroreflective devices” as used herein being intended to encompass generally optical components used for returning radiation automatically from a remote location toward an optical source, and the term “retroreflective systems” as used herein being intended to encompass optical communication links, including but not limited to free-space links, incorporating such retroreflective devices.

### BACKGROUND OF THE INVENTION

Retroreflective devices are inherently capable of reflecting radiation back towards its source, and such devices are frequently used to return radiation in this manner when it is inconvenient or undesirable to actively generate radiation at locations from which data is required to be transmitted. Common examples include the use of special reflective materials for safety clothing or signage, cat's eye markers in road surfaces, and measurement points in land surveying or robotic machinery.

A particular type of retroreflective device currently in common use employs focusing of incident radiation onto a primary reflecting surface. This type is known as a “cat's eye” retroreflector, and commonly employs glass spheres, or cemented hemispheres, in order to provide retroreflection for paraxial incident rays. Such devices can be made very small (for example with sub-millimetre diameters) and offer a very wide field of view, including a complete hemisphere or more in a single component. Furthermore, single spheres can be manufactured in quantity at low cost.

Retroreflective devices may also be used in combination with optical modulation mechanisms in order to establish two-way optical communication between a base station and a location remote therefrom, without needing an optical source at the remote end of the link.

It is an object of the present invention to provide improved retroreflective devices having a modulation mechanism associated therewith.

### SUMMARY OF THE INVENTION

According to a first aspect of the invention, there is provided a retroreflective device comprising:
a lens having a non-planar outer surface; and
a liquid crystal cell having a non-planar layer comprising liquid crystal material, said non-planar layer having a shape related to that of the non-planar outer surface of the lens,
wherein the device includes a reflective part arranged to retroreflect a radiation beam passing through the lens, and the liquid crystal cell is arranged to modulate one or more characteristics of said retroreflected radiation beam.

Embodiments of the invention are thus advantageous for use in applications that require thin, transmissive modulators that are compatible with non-planar retroreflecting devices. Liquid crystals offer a useful modulation action for optical path lengths of 1 mm and less, and, since the local orientation of their molecular symmetry axes can be controlled by the fabrication process so as to vary with position, they can be made to be locally optimum over the whole of the reflecting surface of the non-planar retroreflecting device. In addition, liquid crystal devices are associated with low power requirements, which make them advantageous for use in power-limited applications.

Preferably the liquid crystal cell comprises a transparent electrode layer located between said lens and said liquid crystal material, and comprises a metallic layer that serves both as an electrode and a reflector. Preferably the liquid crystal cell is arranged to change the polarising and/or phase delay characteristic of the cell by the application of suitable electrical signals to the electrode layers.

The metallic layer preferably comprises aluminium, since aluminium reflects radiation adequately and is also a good conductor of electricity which is readily deposited or otherwise provided as a coating upon a suitable support structure envisaged in preferred embodiments of the invention.

In a particularly preferred embodiment, the liquid crystal material is ferroelectric, which provides rapid, reliable and substantially binary switching between two states; the liquid crystal material being aligned to generate a 90 degree switching angle between the two states, which is capable of providing polarisation-independent phase modulation.

The liquid crystal cell can also include an alignment layer located between the liquid crystal layer and the metallic layer.

Spacers such as rods, fibres, balls or beads may be incorporated into the layer of liquid crystal material in order to ensure that the layer conforms to a desired and substantially constant thickness; the spacers may be made from glass.

In one embodiment the lens has a spherical outer surface, and most preferably is a sphere. Thus, in the following description, the term “spherical” is intended to refer to surfaces which include both whole spheres and part-spherical surfaces. The advantages of using a spherical retroreflector, such as a GRIN-sphere retroreflector, as part of the remote terminal of a free space optical communication link include compactness, low cost and wide field of view. The latter advantage brings with it freedom from the need to assemble multiple retroreflector components pointing in different directions, or alternatively to require complex pointing and tracking systems to orientate the retroreflector appropriately. The spherical lens may exhibit a spherically graded refractive index. In other embodiments the lens may have an aspherical outer surface.

In preferred embodiments, transparent material surrounds a substantial part of the lens. In a particularly preferred embodiment, the transparent material surrounds at least approximately one half of the lens, and more preferably surrounds substantially the entire lens.

In one embodiment, the liquid crystal cell is attached to the non-planar outer surface.

In an alternative embodiment, the liquid crystal cell is spaced from said non planar outer surface, a transparent window having a shape related to that of the non-planar outer surface of the lens being disposed between the liquid crystal cell and said lens. In this embodiment, the window may support the transparent electrode layer.

According to a second aspect of the invention there is provided a method of manufacturing a retroreflective device of the type described above. The standard method for manufacturing nominally planar devices involves dispersing spacer particles within the liquid crystal, where the substrate of the cell is mechanically rigid, and the transparent window is mechanically flexible, so that the window can flex to accommodate any non-flatness of the substrate and thereby maintain a fixed gap filled by the liquid crystal. In embodiments of the invention, however, where the retroreflective device is non-planar, there is no means of automatically compensating for such non-flatness, since there is no equivalent mechanically flexible part. Accordingly manufacturing of retroreflective devices according to the invention comprises the steps of:
fabricating a base for the retroreflective device, the base including a non-planar surface for supporting the non-planar layer of liquid crystal material;
locating the lens with respect to the non-planar surface of the base; and
inserting a layer of liquid crystal material between said lens and non-planar surface of the base.

In embodiments of the invention, therefore, fabrication of such a device is a two-step process. In a first step a base support is made, and in a second step the retroreflective device is added thereto.

In one arrangement the base is fabricated with direct reference to the non-planar layer of liquid crystal material. The fabrication process then preferably includes selecting a non-planar device that is identical to the lens forming part of the retroreflecting device; inserting the selected non-planar device into a bath comprising a viscous material such that a portion of the non-planar device extends outwards of the viscous material; applying a spacer layer to the outwardly extending portion of the non-planar device; and covering the spacer layer with a curable resin.

Preferably the viscous material is wax, and the spacer layer is a silicon dioxide layer that is applied by means of a sputtering technique. Conveniently the method includes applying a mould release layer between said spacer layer and said resin, so as to enable separation of the resin from the viscous material and non-planar device once the resin has been allowed to cure for a specified period of time. This curing process thereby provides a base, or support, which includes a non-planar depression corresponding to the outwardly extending portion of the non-planar device.

Having formed the base, or support, for the liquid crystal cell, a metallised electrode layer is applied to the surface corresponding to the outwardly extending portion and an alignment layer applied thereto by means of a sputtering technique. The alignment layer can preferably be imprinted with a plurality of molecular-scale ridges, and covered with spacing devices under control of a pressurized gas flow.

A surface of the lens is coated with a transparent electrode layer to a surface of said lens, which is then positioned onto the spacing devices located on the alignment layer.

In an alternative embodiment, the transparent electrode layer is applied to a surface of a transparent window, the window having a shape related to that of the non-planar lens forming part of the retroreflective device. The window is then positioned onto the spacing devices of the alignment layer, so that the surface supporting the transparent electrode layer is adjacent to said spacers. The lens is then located with respect to the window so that a gap exists between the liquid crystal cell and the lens.

Insertion of the layer of liquid crystal material can include heating a volume of liquid crystal material; and inserting the device into the heated volume under vacuum conditions so as to effect migration of said heated liquid crystal material into the liquid crystal cell, e.g. by capillary action.

According to a third aspect of the invention there is provided a retroreflecting device comprising
a lens having an outer surface; and
a liquid crystal cell having a layer comprising liquid crystal material,
wherein the device includes a part arranged both to retroreflect a radiation beam passing through the lens and to function as an electrode of the liquid crystal cell.

In this aspect of the invention, embodiments combine two required types of functionality into a single layer, which increases the efficiency of the retroreflecting device, whilst minimising the complexities associated with manufacture of the device.

According to a further aspect, embodiments of the invention can be used to transmit information to a source of the radiation incident upon the device. This is of benefit in a number of situations, particularly where covert or confidential communication is required over a free space communications link, since the retroreflection provided by the spherical lens accurately constrains the retroreflected radiation to follow its original path and imposes substantially no spreading thereon.

### BRIEF DESCRIPTION OF THE DRAWINGS

In order that the invention may be clearly understood and readily carried into effect, some embodiments thereof will now be described, by way of example only, with reference to the accompanying drawings, of which:

FIG. 1 shows a retroreflective device in accordance with an embodiment of the invention;

FIG. 2 shows a basic sphere lens forming part of the retroreflective device shown in FIG. 1;

FIGS. 3 and 4 are schematic diagrams illustrating aspects of the processing techniques used in the fabrication of a device such as that shown in FIG. 1; and

FIG. 5 shows, in schematic block diagrammatic form a retroreflective system, in accordance with an example of another aspect of the invention.

### DETAILED DESCRIPTION OF THE DRAWINGS

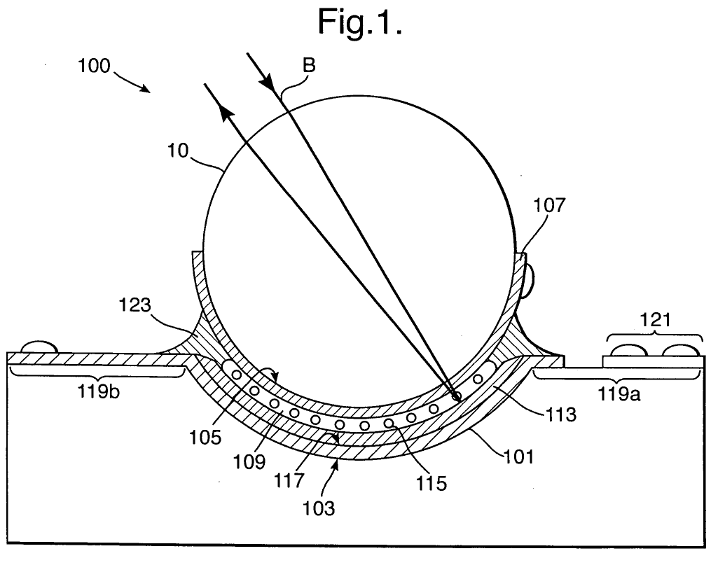

FIG. 1 shows an embodiment of the invention, hereinafter referred to as a retroreflective modulator device 100, arranged to modulate one or more optical characteristics (in preferred embodiments polarisation and/or phase) of incident radiation at the point of reflection so that information can be conveyed to the source of the incident radiation by means of optical modulation superimposed upon the reflected radiation.

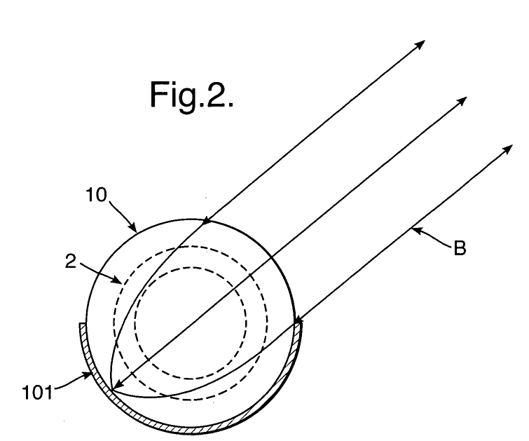

The modulator device 100 comprises a retroreflective device, which is based on a sphere lens and shown in more detail in FIG. 2. An upper face 102 of the mechanical surface of the sphere lens 10 is the face through which an incident radiation beam B (which is assumed to be a parallel beam) passes into the sphere lens. The sphere lens can either have a constant refractive index or have a ‘graded refractive index’ (or GRIN), in which, as is known, the material of the lens exhibits gradual variations in refractive index through its volume. In this example, the sphere lens 10 has a refractive index in the region of 2.0, and is designed to focus incident collimated radiation onto a metallised layer 101, which provides a retro-reflecting action.

The device 100 also incorporates a liquid crystal cell 103, which includes the metallised layer 101, and is disposed adjacent to a rear face 105 of the sphere lens 10 such that the reflected radiation can be modulated. In a known, planar, retroreflecting device incorporating a liquid crystal cell as modulating means, such as that described in U.S. Pat. No. 6,624,916, the liquid crystal cell includes a planar layer of polarisation material adjacent to one face thereof, and a planar reflecting surface adjacent the polarisation layer. The polarisation layer acts to block incident radiation, based on the polarisation thereof, and thus has the effect of modulating the amplitude of retroreflected radiation. U.S. Pat. No. 6,624,916 also shows a combination of a modulating means, namely a SEED modulating device, with a spherical retroreflective lens, unfortunately without any indication of how such a spherical modulating retroreflective device could be made.

In embodiments of the present invention, not only is a method of manufacture disclosed, but the modulating retroreflective device does not include a polarisation layer and particularly advantageously incorporates the required reflective functionality into the LC cell. This means that embodiments of the invention are less complex and thus less costly to manufacture. As a result, and in comparison with the type of modulating achievable with a known liquid crystal based modulator (using the telecentric lens as described in U.S. Pat. No. 6,624,916), modulation of the phase and/or polarisation of the incident light, instead of amplitude, can be effected.

Turning now to the structure of an embodiment of modulator device 100, the liquid crystal cell 103 typically comprises a transparent indium tin oxide (ITO) electrode 107 deposited onto the rear face 105 of the sphere lens 10, a thin layer 109 of ferro-electric liquid crystal material, and the metallised layer 101 described above, which, in this example, is a layer formed on a surface of a part-spherical casting 111. The liquid crystal cell 103 also includes a silicon dioxide (SiO2) layer 113 adjacent the metallised layer 101, the silicon dioxide layer 113 providing, in known manner, alignment of the liquid crystal material 109 in the cell 103. The liquid crystal cell 103 also includes glass rod spacers 115 dispersed in the liquid crystal material 109, to provide uniform cell spacing. In one embodiment the liquid crystal material 109 is aligned to generate a 90-degree switching angle, which provides polarisation-independent phase modulation.

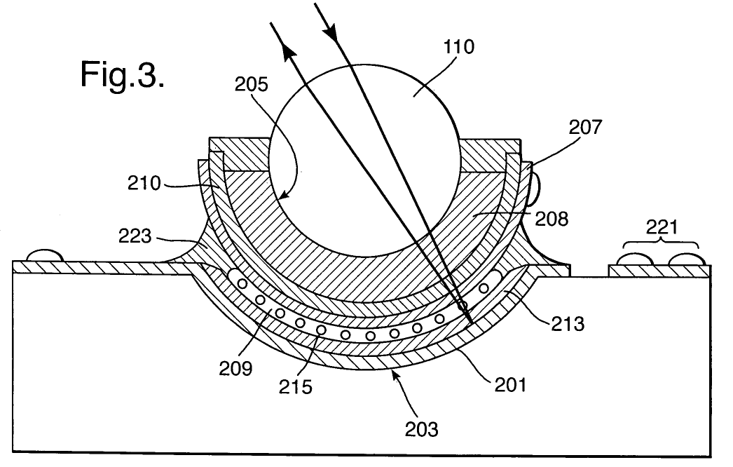

FIG. 3 shows an alternative embodiment of the present invention. Components corresponding to those previously described with reference to FIGS. 1 and 2 are designated with the same reference numerals, incremented by 100. In this embodiment, the focal length of the GRIN-sphere lens 110 is significantly greater than its physical diameter and since the quality of the retroreflection depends on light being focused at the point of reflection, the reflective surface 201 must be positioned at the focal surface of the lens 110. This results in the liquid crystal cell 203 being separated from the lens 110 with a space 208 between the rear face 205 of the lens 110 and the ITO electrode 207 of the liquid crystal cell 203.

A thin window 210 with a spherical outer surface that is concentric with the outer surface 205 of the lens 110, separates the space 208 from the liquid crystal cell 203 and acts as a supporting surface for the ITO electrode 207. The window 210 is preferably formed of glass but any other suitable material having the requisite transparency and stability characteristics can be used. The lens 110 is held in position by means of a prefabricated spacer 212, which is mounted, on the upper end of window 210 as shown. The spacer 212 is preferably formed of glass but other materials such as a ceramic or metal could be used, provided it has the necessary strength and can be manufactured in the appropriate shape. However, it should be understood that various other mechanisms for supporting the lens are also contemplated, such as, for example, a custom-built adjustable mount, which is aligned on testing during manufacture.

Space 208 can be filled with any appropriate fluid but for maximum efficiency, the ratio of the useable lens aperture to the focal length of the device should be kept large and so the refractive index of the space 208 should be kept as close to unity as possible. Therefore, the space is filled with dry air, a gas or vacuum.

As described above, a problem encountered when fabricating a modulator comprising a spherical retro-reflector is that of uniformity of optical path length of incident radiation. Referring to FIGS. 1, 2 and 3, it will be appreciated that in order to ensure that incident radiation is focused onto the reflecting layer 101 at all angles of incidence across the upper face 2, the distance between the rear face 105 and the metallised layer 101 should be substantially uniform along the length of the liquid crystal cell 103. Therefore the spherical surfaces formed by the rear faces 105 and 205 of the sphere lenses 10 and 110, the reflective layers 101 and 201 and the surfaces of the transmitting modulating layers should all be concentric although they possess different radii of curvature. Most preferably the liquid crystal (LC) cells 103 and 203 should be uniform in thickness to within 1 μm tolerance, and a method by which such precision can be achieved will now be described.

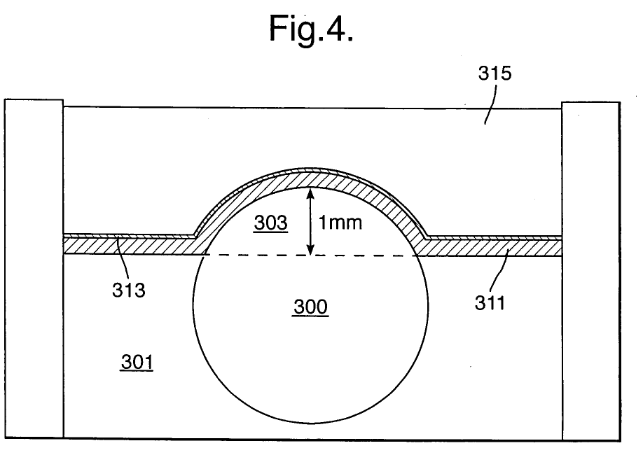

Firstly, manufacture of a casting 111 arranged to support the liquid crystal cell 103 illustrated in FIGS. 1 and 2 will be described. Referring to FIG. 4, in a preferred procedure, a 5 mm diameter (+0/−3 μm, 2 μm sphericity) S-LAH79 glass casting ball 300 (Edmund C47-130) is embedded into a wax mount 301 such that a face 303 of the surface of the ball 300 is left uncovered by the wax. Preferably this face 303 corresponds to a radial distance of 1 mm from an uppermost point on the surface of the ball 300. The face 303 is then coated conformally with a layer 311 of SiO2 in order to increase the effective diameter of the casting ball 300. Next a thin layer 313 of silicone based mould release agent is applied to the SiO2 layer 311, and finally a casting resin 315 is applied to the mould release agent layer 313. A rapid cold curing acrylic resin with negligible shrinkage, such as the material known as Acrulite™ supplied by H. Roberts & Sons, 65 Henton Road, Leicester LE3 6AY and specifically designed for surface copying, is used in this example.

Once the resin 315 has cured, the wax 301, SiO2 layer 311 and mould release layer 313 are removed, leaving the casting 315 (which is the casting 111 that forms the basis of the liquid crystal cell 103). Referring again to FIG. 1, it can be seen that the casting 111 comprises a spherical depression region 117 located between two substantially flat portions 119a, 119b. Since the spherical depression region 117 supports the liquid crystal cell 103 (the metallised layer 101 being formed directly thereon), the uniformity of the liquid crystal cell 103, sandwiched between the spherical depression region 117 and sphere lens 10, is highly dependent on the precision of the casting process described above, and in particular on the nature of the casting ball 300. Most preferably, therefore, the casting ball 300 is similar, if not substantially identical, to the sphere lens 10. It will be appreciated that layers 311, 313 essentially represent the space occupied by the liquid crystal cell 103, so that the effective diameter of the casting 111 is larger than that of the sphere lens 10.

Construction of the LC cell 103 will now be described, with reference to FIG. 1. The metallised layer 101, which preferably comprises an aluminium electrode layer, is deposited onto the surface of the casting 111. A thin (micron-scale) layer 113 of SiO2 is then applied to the metallised layer 101 by means of a RF sputtering technique. As described above, this SiO2 layer 113 provides alignment for the liquid crystal material 109, and is ‘rubbed’ in one direction, using a tool rotating about an axis parallel to the surface of the casting, so as to imprint locating ridges into the SiO2 layer 113. One method of “rubbing” the layer 113 involves swiping the surface 113 using a tool covered with a small piece of felt, thereby imprinting a set of molecular-scale ridges, which are sufficient to align the liquid crystal material 109 (as described below).

A plurality of glass rod spacers 115 is then ‘blown’ into the spherical depression region 117 to define the desired cell thickness (it should be noted that at this point the liquid crystal material 109 has not yet been applied). Adding the glass rod spacers 115 to the LC cell 103 involves placing the LC cell 103 at the bottom of a sealed box (having a volume of approximately 40 cm3); introducing a specified number of glass rod spacers into the box via a small funnel; and blowing the spacers into the box via a burst of N2 gas. The “specified number” of glass rod spacers is ascertained by trial and error with the objective of achieving an area density of 10-20 per mm2-. Once blown into the box, the spacers fall onto the substrate 113 under the influence of gravity, and do not tend to overlap with one another. The glass rod spacers 115 could alternatively be provided by glass fibre or glass balls.

In operation, a voltage is applied to the metallised layer 101, so a small area 121 to one side of the spherical depression region 117 is masked off to isolate a section of the electrode 101.

An approximately hemispherical coating 107 of transparent and conductive indium tin oxide (ITO) is applied to the rear face 105 of the sphere lens 10 (this material can be obtained from Advanced Technology Coatings Ltd. Address: No. 1, Drakes Court, Langage Business Park, Eagle Road, Plympton, Plymouth). This rear surface 105 of the sphere lens 10 is then located onto the spacers 115, and a rim of glue 123 is applied between one of the substantially flat portions 119b of the casting and an exposed portion of the ITO layer 107. The glue functions both to hold the sphere lens 10 in position and to provide a seal for the LC cell 103. The glue seal 123 comprises a small hole (not shown) which allows for insertion of the liquid crystal material 109 and evacuation of air from the liquid crystal cell 103.

A custom built jig is preferably assembled for insertion of the liquid crystal material 109 into the LC cell 103, the jig being arranged to heat the liquid crystal material 109 to a temperature above its transition temperature (at which point it becomes quite liquid), whereupon the LC cell 103 is dipped into the liquid under vacuum, causing the liquid crystal material 109 to be sucked up into the cell through capillary action. The LC cell 103 is then cooled slowly, which allows the liquid crystal material 109 to align itself with the ridged SiO2 layer 113.

Once the LC cell 103 has been assembled, electrical connection is provided to the ITO layer electrode 107 and metallised layer electrode 107 and 101.

It will thus be appreciated that the thickness uniformity of the LC cell 103 depends on several parameters, including the relative diameters and sphericity of the ball used to construct the casting 111 and the sphere lens 10 in operative association with the liquid crystal cell 103, together with any shrinkage associated with the resin casting 111.

In the alternative embodiment illustrated in FIG. 3, manufacture of the casting and construction of the LC cell is identical to that described above, although the window 210 which forms the boundary between the liquid crystal cell 203 and the space 208 could be used in place of the casting ball 300. However, in this embodiment, the coating 207 of transparent and conductive indium tin oxide (ITO) is applied to the rear face of the window 210 which is then located onto the spacers 215, glued and the liquid crystal material inserted in the same way as described above. The spacer 212 is then attached to the upper end of the outer surface of window 210 and the sphere lens 110 is then located thereon so as to leave a space 208 between the rear surface 205 the lens 110 and the outer surface of the window 210. The space 212 is then filled with fluid.

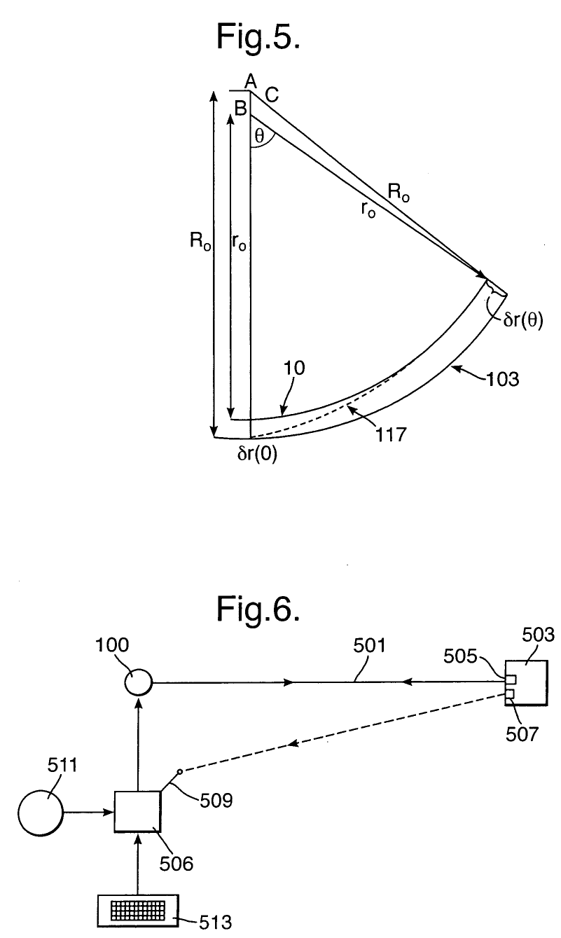

FIG. 5 shows the geometrical relationship between the spherical depression region 117 and the sphere lens 10, where ro represents the radius of the ITO coated sphere lens 10, Ro represents the radius of the spherical depression region 117 and δr(θ) represents the thickness of the LC cell 103. In particular FIG. 4 highlights the lack of concentricity between the sphere lens 10 (centre at point B) and a circle corresponding to the spherical depression region 117 (centre at point A), from which it will be appreciated that δr(θ) will vary as a function of θ. The aim of the manufacturing method described above is to minimise the variation of δr(θ) with θ.

From FIG. 4, the distances AB and AC can be expressed as follows:

$$AB = Ro - ro - δ r ( 0 )$$

$$AC \approx Ro - ro - δ r ( θ )$$

$$For AB ⪡ Ro , ro \text{:}$$

$$AC \approx AB cos θ \\ \approx [ Ro - ro - δ r ( 0 ) ] cos θ$$

$$AC \approx Ro - ro - δ r ( θ )$$

$$δ r ( θ ) \approx Ro - ro - AC$$

Substituting for AC:
δr(θ)≈Ro−ro−[Ro−ro−δr(0)]cos θ

Thus
δr(θ)≈ΔR(1−cos θ)+δr(0)cos θ (1)
where ΔR=Ro−ro.

The smaller of δr(θ) and δr(0) is determined by the size of the glass spacers 115, while trial casting events determine the degree of shrinkage incurred during the curing process.

Initially, θ is set to approximately 45 degrees, hence Equation (1) becomes:
δr(θ)≈0.3ΔR+0.7δr(0) (2)

The intention is to employ a conformal layer thickness in the casting stage such that ΔR=δr(0) and hence δr(θ)≈δr(0). The cell thickness is then constant with θ.

For 90 degree switching of the LC cell 103, and an operating wavelength of 1.3 μm, the optimum cell thickness, δr, is several μm.

Alternative procedures may of course be used for the manufacture of devices such as that shown in FIG. 1, depending upon various criteria, such as overall dimensions, performance requirements and operational demands such as robustness.

Referring now to FIG. 5, there is shown a retroreflective system incorporating a retroreflective device 100 of the kind described with reference to FIG. 1.

The device 100 is arranged to receive radiation along path 501 from a base station 503 disposed at a location remote from the device 100. In this example, the radiation projected along path 501 comprises coherent light at one or more predetermined wavelengths generated by a laser device 505 located at the base station 503. In a relatively simple mode of operation, the LC cell forming part of the device 100 is modulated in response to information to be conveyed to the base station 503 in real time; the information thus being superimposed upon the light retroreflected towards the base station 503 over a free-space link. Such operation is acceptable in some circumstances, but implies substantially continuous illumination of the device 100 by the laser light from device 505. In many circumstances therefore it is preferred that the information used to modulate the device 100 (e.g. data from sensor 511) is not transmitted in real time, but is stored in a storage means 506 sited at the location of the retroreflective device 100 for transmission to the device 100 when called for. The call may comprise an interrogating trigger signal, sent over an optical or other communications link, such as a microwave link, from a device 507 located at the base station 503 to a sensor 509 associated with the store 506. Receipt of the trigger signal causes the store 506 to replay at a given speed (usually significantly faster than real time) the information stored therein, thereby to effect modulation of the LC cell of the device 100 and thus of any light beam transmitted over path 501. The trigger signal, or a further signal derived from it, may be used to energise the laser device 505, causing it to illuminate the device 100 via path 501.

In an alternative arrangement the trigger signal could originate from the storage device 506, causing the laser device 505 to be energised at the same time as sending the modulating data received from the sensor 511 to the device 100.

It will be appreciated that the information may be coded in accordance with any chosen format if desired. It will also be appreciated that the light may be transmitted to and from the device 100 over a closed communications link, such as a fibre optic cable, instead of, or in addition to the free-space transmission illustrated schematically in FIG. 5.

The information transmitted to the base station by modulation of retroreflected light as described above may be derived from any source and input to the store 506, or to an alternative driver for the LC cell of the device 100, in any convenient manner. As shown schematically in FIG. 5, the information may be derived from a sensor 511, or may be downloaded from a computer device 513, such as a laptop computer, temporarily connected to an input port of the store 506 subject to authorisation.

If a sensor such as 511 is used, it may be sensitive to anything of interest, such as weather or other environmental variations, the presence of dangerous chemicals and so on.

The above embodiments are to be understood as illustrative examples of the invention. Further embodiments of the invention are envisaged. It is to be understood that any feature described in relation to any one embodiment may be used alone; or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A retroreflective device comprising:
a lens having a non-planar outer surface; and
a liquid crystal cell having a non-planar layer comprising liquid crystal material, said non-planar layer having a shape related to that of the non-planar outer surface of the lens,
wherein the device includes a reflective part arranged to retroreflect a radiation beam passing through the lens, and the liquid crystal cell is arranged to modulate one or more characteristics of said retroreflected radiation beam.

2. A retroreflective device according to claim 1, wherein the liquid crystal cell comprises a metallic layer that serves both as an electrode and said reflective part.

3. A retroreflective device according to claim 2, the liquid crystal cell including an alignment layer located between the liquid crystal layer and the metallic layer.

4. A retroreflective device according to claim 2, wherein the metallic layer comprises aluminium.

5. A retroreflective device according to claim 1, wherein the liquid crystal cell comprises a transparent electrode layer located between said lens and said liquid crystal material.

6. A retroreflective device according to claim 1, wherein the liquid crystal layer include spacers arranged so as to ensure that the liquid crystal layer conforms to a substantially constant thickness.

7. A retroreflective device according to claim 6, wherein the spacers comprise any one of rods, fibres or balls.

8. A retroreflective device according to claim 1, wherein the liquid crystal material is ferroelectric.

9. A retroreflective device according to claim 1, wherein the liquid crystal cell is attached to said non-planar outer surface.

10. A retroreflective device according to claim 1, wherein the liquid crystal cell is spaced from said non-planar outer surface.

11. A retroreflective device according to claim 10, wherein a transparent window having a shape related to that of the non-planar outer surface of the lens is located between the liquid crystal cell and said lens.

12. A retroreflective device according to claim 11, wherein the transparent electrode layer is supported by said window.

13. A retroreflective device according to claim 2, including an electrical source arranged to apply electrical signals to the electrode layer and to the metallic layer, thereby changing an optical characteristic of the radiation beam passing through the lens.

14. A retroreflective device according to claim 1, wherein the lens has a spherical outer surface.

15. A device according to claim 1, wherein the lens comprises a graded refractive index lens.

16. A method of manufacturing a retroreflective device according to claim 1, including:
fabricating a base for the retroreflective device, the base including a non-planar surface for supporting the non-planar layer of liquid crystal material;
locating the lens with respect to the non-planar surface of the base; and
inserting a layer of liquid crystal material between said lens and non-planar surface of the base.

17. A method of manufacturing a retroreflective device according to claim 16, wherein the step of fabricating the base includes
selecting a non-planar device;
inserting the selected non-planar device into a bath comprising a viscous material such that a portion of the non-planar device extends outwards of the viscous material;
applying a spacer layer to the outwardly extending portion of the non-planar device; and
covering the spacer layer with a curable resin.

18. A method according to claim 16, in which the step of selecting a non-planar device includes selecting a non-planar device that is substantially identical to the non-planar lens forming part of the retroreflective device.

19. A method according to claim 17, including applying the spacer layer by means of a sputtering technique.

20. A method according to claim 17, including applying a mould release layer between said spacer layer and said resin.

21. A method according to claim 17, including, after a predetermined curing time has elapsed, removing the cured resin from the spacer layer, said cured resin providing said base.

22. A method according to claim 16, including applying a metallised electrode layer to the base.

23. A method according to claim 16, including applying an alignment layer to the base by means of a sputtering technique.

24. A method according to claim 23, including imprinting a plurality of molecular-scale ridges into the alignment layer.

25. A method according to claim 23, including applying a plurality of spacing devices to the alignment layer.

26. A method according to claim 25, including applying the spacing devices under control of a pressurized gas flow.

27. A method according to claim 16, including applying a transparent electrode layer to a surface of said lens.

28. A method according to claim 16, including selecting a transparent window having a shape related to that of the non-planar lens forming part of the retroreflective device and applying a transparent electrode layer to a surface of said window.

29. A method according to claim 28, including locating the window onto the spacing devices, so that the surface supporting the transparent electrode layer is adjacent to said spacers.

30. A method according to claim 29, wherein the step of locating the lens with respect to the non-planar surface of the base includes locating the lens in relation to the window so that a gap exists between the liquid crystal cell and the lens.

31. A method according to claim 16, in which the step of inserting a layer of liquid crystal material includes:
heating a volume of liquid crystal material; and
inserting the device into the heated volume under vacuum conditions so as to effect migration of said heated liquid crystal material into the liquid crystal cell.

32. A method according to claim 31, including creating a seal between the base and the lens.

33. A retroreflective system including at least one retroreflective device according to claim 1 and means configured to transmit data to a source of radiation incident upon the device by controlled application of said modulation.

34. A system according to claim 33 wherein said data is transmitted over a free space communications link.

35. A system according to claim 33 wherein the retroreflective device is arranged to emit signals in response to application of said modulation, the system including a phase modulation detector arranged to receive said emitted signals.

36. A retroreflecting device comprising
a lens having an outer surface; and
a liquid crystal cell having a layer comprising liquid crystal material,
wherein the device includes a part arranged both to retroreflect a radiation beam passing through the lens and to function as an electrode of the liquid crystal cell.
